(19) United States
(12) Patent Application Publication
(10) Pub. No.: US 2003/0188661 A1
(43) Pub. Date: Oct. 9, 2003

(54) Method for regulating the tension of a web

(76) Inventor: Michael Heinz Fischer, (US)

Correspondence Address: Douglas R Hanscom, Jones Tullar & Cooper, Eads Station, P O Box 2266, Arlington, VA, 22202, US

(21) Appl. No.: 10/312,596

(22) PCT Filed: Jul. 19, 2001
(86) PCT No.: PCT/DE01/02717

(30) Foreign Application Priority Data
Jul. 22, 2000 (DE) 100 35 787.3

(51) Int. Cl. B41F 5/04; B41L 1/02

(52) U.S. Cl. 101/485; 101/219

(57) ABSTRACT

The tension of a web in a rotary printing press is regulated during passage of the web between at least first and second cylinders of at least one printing group. The two cylinders are driven using at least one drive mechanism. A distance between the two cylinders is varied to influence the web tension before, between and after the printing groups.

The invention relates to a method for regulating a web tension in accordance with the preamble of claim 1 or 2.

A registration-maintaining drive mechanism for a rotary printing press is known from EP 0 951 993 A1, wherein a longitudinal stretching of the web of material to be imprinted is determined from the web tension values and operating values of the drive mechanisms and is compensated by adjusting the circumferential registration at the cylinders or the registration rollers.

Printing groups are disclosed in DE 42 11 379 A1, whose rubber blanket cylinders are seated in adjustable eccentric bushings, wherein the contacting of the cylinders is varied by pivoting around the first eccentric axis, and a variation of the printing width of an ink application roller in respect to the screen roller is provided by pivoting around the second eccentric axis.

The object of the invention is based on creating a method for regulating a web tension.

In accordance with the invention, this object is attained by means of the characteristics of claims 1 or 2.

The advantages to be gained by means of the invention consist in particular in that the printing groups, or print units, can be regulated in a simple manner via the existing tensile stress, or tension, of the web, for example the web of material to be imprinted or paper web. This is achieved by changing the pressure feed adjustment between the cylinders which interact with each other via the web, in an advantageous manner with “rubber against rubber pressure” of the two interacting transfer cylinders of a printing group.

The conveying behavior of a web through a printing press is subjected to many influences, such as for example the tension/stretching characteristics of the respective paper, and therefore the prevailing tension, the instantaneous moisture, the sensitivity to moisture, the penetration behavior of moisture into the web, the position of the roll while being produced on the reel spool which, for example, finds its expression in variations of the winding hardness, and location-dependent variations in the module of elasticity. Besides this, it is also a function of the dressing and the contact pressure.

By means of the method it is possible in an advantageous manner to affect the conveying behavior of the web through one or several printing groups of the printing press and to regulate it without a change of rubber blankets of different thickness, or a change in running the process, for example a change of dampening, being required. A change in the tension of the web can be counteracted during the printing process by changing the conveying behavior. The employment of different rubber blankets or different types of paper is also possible, since by means of the method the conveying behavior and the print quality can be changed by changing the distance rather than the thickness of the rubber blankets.

In a reversed way it is possible to use rubber blankets with different conveying behavior, of different quality and/or of different thickness, wherein the desired web tension, or graduation of the web tension between the printing groups can be automatically maintained almost constant.

Thus, rubber blankets from certain manufacturers act in a “negatively conveying manner”, for example, i.e. the web is braked, while others act in a “positively conveying manner”, i.e. the web is “pushed along” in addition to unwinding at the nip location.

The conveying behavior of the web is also a function of the contact pressure between the rubber blankets and the paper web.

In an advantageous embodiment the transfer cylinders are driven in pairs by their own drive mechanism. The forme cylinders interacting with the transfer cylinders, together with ink and dampening units, are embodied to be individually driven and are only electrically synchronized with the transfer cylinders. The advantages resulting from this are, inter alia, the avoidance of gear tooth play in case of a mechanical coupling of the transfer and forme cylinders, for example, and an almost torsion-proof and angle-synchronous driving of the forme cylinders in respect to the transfer cylinders. Further than that, fluctuations of torque, for example caused by distributing rollers or siphon ink units, are damped by the separate drive mechanisms for the forme cylinders, together with the ink and dampening units, and are not transmitted to the transfer cylinders. This results in a printing process which is undisturbed to a great extent.

An exemplary embodiment of the invention is represented in the drawings and will be described in greater detail in what follows.

Shown are in:

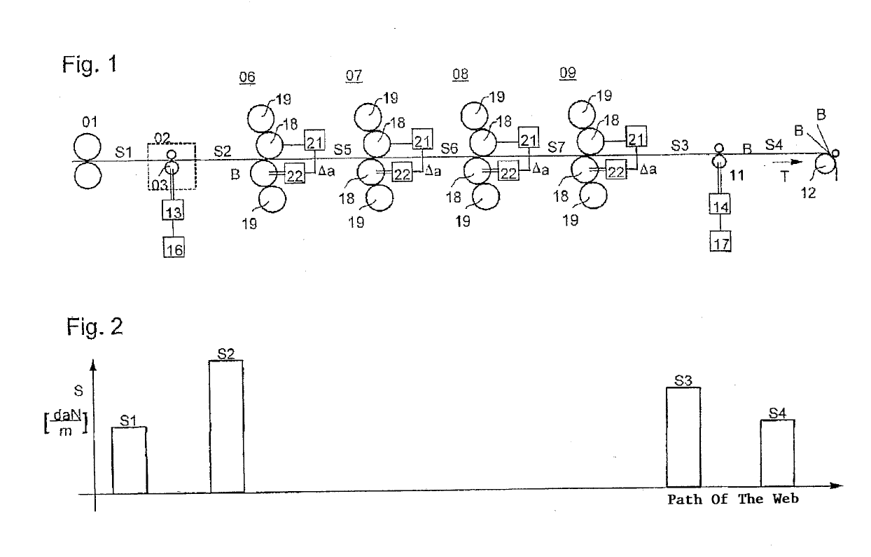

FIG. 1, a schematic representation of the path of a web from the draw-in unit over four printing groups and a second traction roller up to a hopper inlet roller,

FIG. 2, a schematic representation of the tension in the web during the production run,

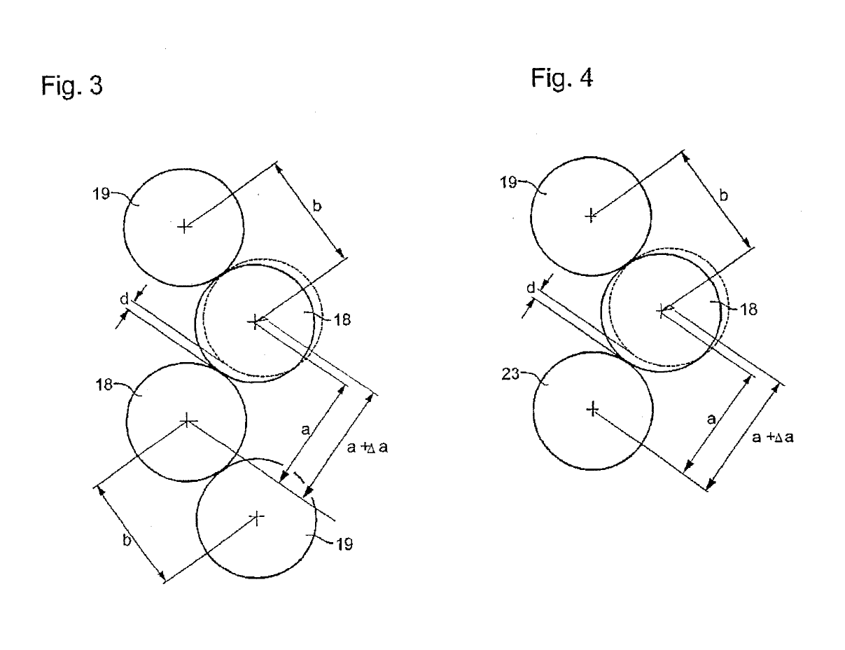

FIG. 3, a schematic representation of a rubber-against-rubber printing group without the representation of the ink unit or possibly the dampening unit,

FIG. 4, a schematic representation of a rubber blanket/counter-pressure cylinder printing group without the representation of the ink unit or possibly the dampening unit,

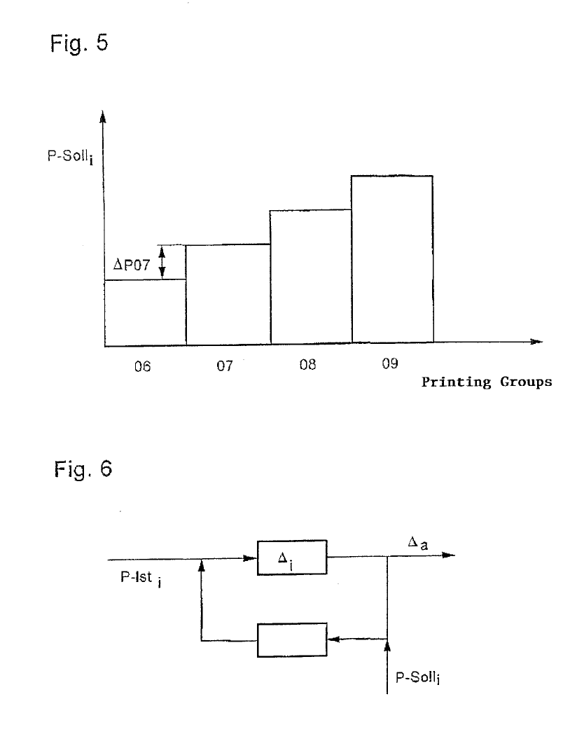

FIG. 5, by way of example, the dependence of the set points for the power consumption of the drive mechanisms for the transfer cylinders driven in pairs,

FIG. 6, a schematic representation of the control circuit for a printing group i.

The path of a web B, for example a web B of material to be imprinted, or a paper web B, on its way through a printing press, in particular a web-fed rotary printing press, is represented in FIG. 1. The web B runs in the conveying direction T from the roll changer 01 through a draw-in unit 02 with a traction roller 03 through, for example, printing groups 06 to 09, to a second traction roller 11. Turning bars, cutters, further traction or guide rollers, and finally the hopper inlet roller, for example, all not represented, follow behind the second traction roller 11. The essential traction rollers 03, 11 are each preferably equipped with their own drive mechanisms 13, 14 and a drive control device 16, 17. In a preferred embodiment, the tensions S1, S2, S3, S4 in the web B are measured upstream of the draw-in unit 02, between the draw-in unit 02 and the first printing group 06, as well as between the last printing group 09 and the traction roller 11, and on the free path between the traction roller 11 and the hopper inlet roller 12. This can be done, for example, via measuring rollers or by the power consumption of the drive motors of the traction units.

If, in particular during a multi-web operation, several webs B are combined at the hopper inlet by means of the hopper inlet roller 12, the base points for adjusting the tensions in the web B are the absolute and relative tensions S4 of the individual webs B in respect to each other at the hopper inlet roller 12 (several webs indicated in FIG. 1). Accordingly, the adjustment of the tensions in the web B takes place starting with the desired level at the hopper inlet roller 12. The base level of the tension in the web B is preferably set by an adjustment at the draw-in unit 02. A change of the level of the tension in the web B also takes place in an advantageous manner by changing the tension S2 at the draw-in unit 02. Therefore, for stretching the web B the first traction roller 03 is operated lagging behind the press speed. During the production run, i.e. at printing speed and with the addition of water and/or ink, the second traction roller 11 is as a rule operated at a higher speed than the press speed of the rotating cylinders 18, for example the transfer cylinders 18.

For the production run at production speed, the traction rollers 03, 11, as well as the hopper inlet roller 12, and possibly those drive mechanisms located between the second traction roller 11 and the hopper inlet roller 12, can be regulated in respect to speed, torque or rotational position. The traction roller 03 in particular can be regulated in such a way that the tension S2 between the draw-in unit 02 and the first printing group 08 is continuously returned to a set point.

For running a dry web B it is advantageous if ahead of the first printing group 06 and downstream of the last printing unit 09, as well as between the printing units 06 to 09, the same tensions S2 and S3, or S5 to S7, of the web B prevail.

With the addition of water and/or ink, the tension or stretching behavior, as well as the conveying behavior of the web B, changes during its passage through the individual printing stations of the printing groups 06 to 09.

As schematically represented in FIG. 2, during the production run a basic setting of the tensions S2 and S3 ahead of the first printing group 06 and following the last printing group 09 is provided by means of customary control and regulating techniques, for example by means of the traction roller 03, which is regulated as to web tension, speed or position, the also regulated hopper inlet roller 12 and/or by compensating rollers, not represented. This state of the web B which, as a rule is tension-regulated, also takes a change in the length of the web B, which takes place after and during the passage through the printing groups 06 to 09 because of the effects of moisture, into consideration by means of the lagging of the traction roller 03 and a speed-up of the traction roller 11 in respect to the press speed. It is also possible to already take symmetrical and stationary fan-out formations in the transverse registration into consideration here.

The conveying behavior and the tension S5 to S7 of the web B between the printing groups 06 to 09 also changes if the print on position is assumed and water and ink are added, when a change to another type of paper is made, or when process parameters, such as the addition of the dampening agent amount, for example, are changed. In the course of the web B passing through several printing groups 06 to 09, a considerable change in the paper properties can take place in the continuing travel in the conveying direction T, which in turn causes a difference in the conveying behavior of the web B in its travel through the printing groups, for example 06 to 09. Thus, for example, depending on the type of paper and the free path length between the printing groups 06 to 09, the moisture has already completely penetrated the web B, partially even before reaching the third printing location, in this case the third printing block 08, for example.

Now, in order to counteract the changes or fluctuations in the conveying behavior and/or changes in the tension S5 to S7 of the web B in the course of passing through the printing groups 06 to 09 during the production run, the distance a between the two cylinders 18 of the printing group 06, 07, 08, 09, which interact with each other via the web B, can be changed (FIG. 3). This can take place in such a way that a detent for the print-on position can be changed. The web B extends between the cylinders 18, which can be moved radially in respect to each other over a distance a, and in the print-on position it is stretched between them. The two cylinders 18, whose distance a in relation to each other can be changed, represent two transfer cylinders 18 during rubber-against-rubber printing. This change of the distance a between the two interacting transfer cylinders 18, for example over a distance Delta a, is preferably performed in such a way that at the same time a distance b between the transfer cylinder 18 and a cylinder 19, for example a forme cylinder 19 interacting with it, is retained.

Customarily the print-on, or print-off position of the transfer cylinder 18 and forme cylinder 19 in relation to each other is achieved by means of the pivoting of eccentric bushings, which receive the journals of the transfer cylinder 18 or forme cylinder 19. The change of the distance a can for example take place by means of a second device, wherein the change of the distance a must not result in a change of the distance b. This can be achieved for example by means of a second eccentricity of the eccentric bushings receiving the journals. However, it is also possible for example to use a paper thickness adjustment already provided on the press for this change. With a suitable arrangement of the respective transfer cylinders 18 and forme cylinders 19 in relation to each other, an approximately linear displacement of one of the transfer cylinders 18 is also conceivable. The change in the distance a is preferably performed by means of the setting of a second eccentric bushing at one of the two interacting transfer cylinders 18, as indicated in FIG. 3 in a greatly overdrawn manner. Setting of the distance a, in the example the setting of the second eccentric bushing, takes place by means of a setting member 21, for example in a hydraulic, pneumatic, mechanical, electrical manner or combination thereof.

The described change in the conveying behavior by varying the distance a by a change Delta a takes place only in the area in which the web B is still stretched between the transfer cylinders 18, i.e. is conveyed. Thus, this regulation of the tension of the web B and of the conveying behavior takes place in the print-on position of the interacting transfer cylinders 18. In the print-on position, a print gap d between the surface areas of the two transfer cylinders 18 interacting via the web B is less in every phase, or at most equal to the thickness of the web B at the corresponding location.

If now a change in the conveying behavior of the web B occurs at one or several printing groups 06 to 09, a change of the distance a, for example by the amount of the change Delta a, is possible, which results in an increase or decrease of the printing gap d. Setting of the setting member 21, and therefore the change Delta a of the distance a, can be performed by the operator himself, for example from a control console, by means of a value for the change Delta a as the setting value Delta a transmitted to the setting member 21, or at the printing group by actuating an appropriate key. For example, the setting member 21 displaces a detent against which the respective transfer cylinder 18 has been placed in the print-on position. Thus, during the production run the operator can affect the conveying behavior of the web B between the printing groups 06 to 09 while the production is running.

In a preferred embodiment, the regulation of the conveying behavior of the web B between the printing groups 06 to 09 takes place automatically and has been integrated into a regulation concept for the tension of the web B, for example, which regulates the tension and stretching ahead of the first printing group 06 and following the last printing group 09 for compensating changes in the stretching of the web B on account of changes of the properties of the paper.

The regulation of the conveying behavior of the web B in, or between the printing groups 06 to 09 takes place in an advantageous manner by means of parameters of the drive mechanisms 22. An actual value X-Ist₁ of a parameter X-Istᵢ is measured at the drive mechanism 22 in the printing group i and is compared with a set point X-Sollᵢ. A deviation Deltaᵢ is used for regulating, and if required changing, the distance a between the cylinders 18. The drive mechanism 22 of the transfer cylinders 18 is preferably regulated to a constant circumferential speed, or angular speed.

Preferably the regulation of the conveying behavior of the web B in, or between the printing groups 06 to 09 takes place by means of the power consumption P-Istᵢ (for the printing group i) of the drive mechanisms for the cylinders 18 interacting with the web B, in the example the transfer cylinders 18. In order to keep the influence of the forme cylinders 19, and possibly of the ink and/or dampening units (not represented) mechanically coupled with them, as low as possible in the course of the measurement of the power consumption, the two transfer cylinders 18 per printing group 06 to 09 are preferably driven in pairs by their own drive mechanisms 22, and the forme cylinders 19, together with the associated ink and possibly dampening units, interacting with them are driven by their own drive mechanisms 23. In an embodiment of the invention, each pair of transfer cylinders 18 is coupled mechanically, for example by means of gear wheels or belts. However, every transfer cylinder 18 can be individually driven and electronically synchronized. A change in the tension, or the conveying behavior, results in a change of the power consumption P-Istᵢ of the drive mechanisms 22, which are preferably rpm-controlled.

Provided that it is appropriately standardized, the power consumption P-Istᵢ by the drive mechanisms 22 of a pair of cylinders 18 interacting with the web B is a measure of the work performed per unit of time by the drive mechanisms 22, and in turn represents a measure of the relations of the tensions S2, S5, S6, S7, S3 ahead of and following the cylinders 18, as well as of the conveying behavior of the web B. Accordingly, set points P-Sollᵢ (printing group i) for the power consumption of the drive mechanism 22 are fixed for the successive printing groups 06 to 09. As a rule, these differ from each other for the printing groups 06 to 09 which are being passed one after the other in the conveying direction T (FIG. 5). In the example, these set points P-Soll₀₆ rise from the first printing group 06 with P-Soll₀₆ of approximately 4 kW to the fourth printing group 09 with P-Soll₀₉ of approximately 7 kW. However, it is possible to preset as set points also set points Delta Pᵢⱼ-Soll of the power consumption of the respective differences Delta Pᵢⱼ=P-Istᵢ, P-Istⱼ, between two successive printing groups i and j, for example Delta P_{07,08}=1 kW.

The instantaneous power consumption P-Istᵢ is compared with the respective set point P-Sollᵢ, or the differences Delta Piⱼ with the set point Delta P-ᵢⱼ-Soll. If a deviation Deltai, or Deltaᵢⱼ from the set point P-Sollᵢ, or Delta Pᵢⱼ-Soll is measured, this is processed in the control circuit, as schematically indicated in FIG. 6, and a change of the distance a by the value Delta a is effected via the setting member 21. This results in a larger, or lesser, print gap d, or rubber blanket projection between the two interacting transfer cylinders 18, and therefore a changed conveying behavior of the web B in the respective printing group i (with i as 06, 07, 08, 09). Now the changed conveying behavior of the web B itself changes the power consumption P-Istᵢ of the drive mechanism of the i-th printing group. This power consumption P-Istᵢ is monitored and returned to the control circuit.

Other suitable parameters of the drive mechanisms 22 can also be used for regulating the printing gap d in the print-on position, i.e. when the web B is stretched between the transfer cylinders 18 and is therefore being conveyed. It is also possible to use measured values of the tension S5 to S7 between the printing groups 06 to 09 for regulating the distance a, or the printing gap d. However, the use of already existing output data is advantageous, since this requires less additional outlay.

In the case of cylinders 18, 23 controlled to a constant moment, the parameter can be the angular speed, for example, which changes when tension or conveying behavior changes. It is now possible to counteract this change again by changing the distance a.

If the transfer cylinder 18 does not interact via the web B with a second transfer cylinder 18, but instead with a counter-pressure cylinder 23 (FIG. 4), the transfer cylinder 18 is placed against the counter-pressure cylinder 23 by means of the web B, or vice versa, for the print-on position. To change the tensions S5 to S7, the distance a between the transfer cylinders 18 and the interacting counter-pressure cylinder 23 is changed. Both cylinders 18, 23 interacting with each other via the web B, for example two rubber blanket cylinders 18, or one rubber blanket cylinder 18 and one counter-pressure cylinder 23, can be moved for changing the distance a. The described method also includes variants wherein one counter-pressure cylinder 23 interacts with two or more transfer cylinders. Changes of the respective tension of the web B in the print-on position take place in that the distance a between the counter-pressure cylinder 23 and the rubber blanket cylinder 18 is varied.

The two cylinders 18, 23, interacting via the web B and stretching the latter, can also be arranged at another location of a printing press, in a paper-making machine or a rolling mill, for example in a lacquering arrangement, a dryer, a superstructure of a painting or rolling arrangement, a calender, or other installations in which a web B is guided.

A change of the tension relationships, or a change in the conveying behavior are detected by means of a parameter which defines the tension conditions. It can also be a value other than the power consumption P-Istᵢ, for example a change of the angular speed in the case of cylinders 18, 23 which are controlled in respect to a constant moment, or also a direct measurement of the tension. The change of this value represents a measure of the values “tension” and “conveying behavior”, which mutually affect each other. In particular, it identifies a change of the relationships of the tension S2, S3, S5, S6, S7 of the web B ahead of and following the printing groups 06, 07, 08, 09, or a change in the resultant conveying behavior. The deviation of the value characterizing the tension relationships from the set point X-Sollᵢ is now used for changing the distance a between the cylinders 18, 23, which affects the conveying behavior of the web B.

In this way the printing groups 06, 07, 08, 09 can be controlled to an approximately constant tension S2, S3, S5, S6, S7 of the web B ahead of, following and/or between the printing groups 06, 07, 08, 09.

List of Reference Symbols

01 Roll changer

02 Draw-in unit

03 Traction roller

04 -

05 -

06 Printing group, first

07 Printing group, second

08 Printing group, third

09 Printing group, fourth

10 -

11 Traction roller

12 Hopper inlet roller

13 Drive mechanism

14 Drive mechanism

15 -

16 Drive control device

17 Drive control device

18 Cylinder, transfer cylinder

19 Cylinder, forme cylinder

20 -

21 Setting member

22 Drive mechanism

23 Counter-pressure cylinder

B Web, web of material to be imprinted, paper web

T Conveying direction

a Distance (18)

b Distance (18, 19)

d Print gap

S1 Tension

S2 Tension

S3 Tension

S4 Tension

S5 Tension

S6 Tension

S7 Tension

Delta a Change, set value

Deltaᵢ Deviation

DeltaPᵢ Difference

DeltaPᵢⱼ-Soll Set point

P-Istᵢ Power consumption of the printing group i, wherein

i=06 to 09

P-Sollᵢ Set value for the printing group i, wherein

i=06 to 09

X-Istᵢ Actual value

X-Sollᵢ Set point

1. A method for regulating a tension (S2, S3, S5, S6, S7) of a web (B), wherein the web (B) is stretched between a pair of cylinders interacting with each other via the web (B), and having a first cylinder (18) and a second cylinder (18, 23), characterized in that for regulating the tension (S2, S3, S5, S6, S7) of the web (B) a change (Delta a) of a distance (a) between the two cylinders (18, 23) takes place.

2. A method for regulating a tension (S2, S3, S5, S6, S7) of a web (B), wherein the web (B) is stretched between a pair of cylinders interacting with each other via the web (B), and having a first cylinder (18) and a second cylinder (18, 23), and an actual value (X-Istᵢ) of a parameter, which defines the relationship of the tension of the web (B) ahead of and following the cylinders (18, 23) is measured and compared with a set point (X-Sollᵢ), characterized in that on the basis of a deviation (Deltaᵢ) of the measured actual value (X-Istᵢ) from the set point (X-Sollᵢ) a change (Delta a) of a distance (a) between the cylinders (18, 23) interacting via the web (B) takes place.

3. The method in accordance with claim 1, characterized in that the change (Delta a) of the distance (a) between the two cylinders (18, 23) interacting with the web (B) takes place on the basis of a deviation (Deltaᵢ) of the measured actual value (X-Istᵢ) from the set point (X-Sollᵢ) of a parameter, which defines the relationships of the tension of the web (B) ahead of and following the cylinders (18, 23).

4. The method in accordance with claim 2 or 3, characterized in that the two cylinders (18, 23) are driven by at least one drive mechanism (22).

5. The method in accordance with claim 4, characterized in that the actual value (X-Istᵢ) of the parameter is determined at the drive mechanism (22).

6. The method in accordance with one of claims 1 or 2, characterized in that the first (18) and the second cylinder (18, 23) are arranged in a printing group (06, 07, 08, 09) of a printing press, in particular a rotary printing press.

7. The method in accordance with claim 5, characterized in that a power consumption (P-Istᵢ) of the drive mechanism (22) is detected as the actual value (X-Istᵢ), and a set point (P-Sollᵢ) is preset as the set point (X-Sollᵢ) of the power consumption.

8. The method in accordance with claim 6, characterized in that the two cylinders (18) interacting with the web (B) are embodied as transfer cylinders (18), and are driven by a common drive mechanism (22).

9. The method in accordance with claim 8, characterized in that each of the transfer cylinders (18) interacts with a forme cylinder (19), and that this forme cylinder (19) is mechanically decoupled from the drive mechanism (22) of the transfer cylinder (18).

10. The method in accordance with claim 6, characterized in that the first cylinder (18) is embodied as a transfer cylinder (18), and the second cylinder (23) as a counter-pressure cylinder (23) interacting with the first via the web (B), that the transfer cylinder (18) interacts with a forme cylinder (19), which is mechanically decoupled from the drive mechanism (22) of the transfer cylinder (18).

11. The method in accordance with claim 10, characterized in that a change (Delta a) of the distance (a) between the transfer cylinder (18) and the counter-pressure cylinder (23) takes place.

12. The method in accordance with one of claims 9 or 11, characterized in that during the change of the distance (a) by a change (Delta a), a distance (b) between the transfer cylinder (18) and the forme cylinder (19) interacting with it is kept approximately constant.
